(19) United States
(12) Patent Application Publication
(10) Pub. No.: US 2021/0218863 A1
(43) Pub. Date: Jul. 15, 2021

(54) TRANSMITTING APPARATUS AND IMAGE FORMING APPARATUS

(71) Applicant: KYOCERA Document Solutions Inc., Osaka (JP)

(72) Inventor: Takeo SHIMIZU, Osaka (JP)

(73) Assignee: KYOCERA Document Solutions Inc., Osaka (JP)

(21) Appl. No.: 17/057,974

(22) PCT Filed: Mar. 26, 2019
(86) PCT No.: PCT/JP2019/012905

§ 371 Date: Nov. 23, 2020

(30) Foreign Application Priority Data
May 30, 2018 (JP) 2018-103929

(51) Int. Cl. H04N 1/32; H04N 1/00

(52) U.S. Cl. CPC H04N 1/32096; H04N 1/00411; H04N 2201/0039; H04N 1/00424; H04N 1/00217

(57) ABSTRACT

A transmitting apparatus includes: an image reading device that obtains image data; an operating device for specifying a transmission destination of the image data; a communication device that transmits the image data to a transmission destination specified through the operating device; a display; an HDD; and a controller. When a broadcast transmission is performed, the controller makes a plurality of transmission destinations to which the broadcast transmission has been performed correspond to one another and causes the HDD to store the plurality of transmission destinations as history information. When the transmission destination specified through the operating device is included in the history information, the controller causes the display to display, as first information, the transmission destinations stored in the storage device in correspondence to the transmission destination specified.

### TECHNICAL FIELD

The present invention relates to transmitting apparatuses and image forming apparatuses, and particularly relates to a technique of displaying transmission destinations of data.

### BACKGROUND ART

A technique of displaying destination candidates of data when sending the data to a specified transmission destination is known.

Patent Literature (PTL) 1, for example, discloses the technique in which when user's pinch-in operation is received while names registered in address book data are being displayed in an order, names that are frequently used are displayed.

Patent Literature (PTL) 2 discloses the technique in which mail addresses to be transmission origins and mail addresses registered as destinations are stored by being associated with usage in advance, respectively; and when a transmission origin mail address is selected in creating an e-mail, a list of destinations, which are associated with the same usage name as the usage name corresponding to the mail address, is displayed.

### CITATION LIST

### Patent Literature

Patent Literature 1: JP-A-2014-229161

Patent Literature 2: JP-A-2003-281043

### SUMMARY OF INVENTION

When performing a broadcast transmission by which the same data is sent to more than one transmission destination, a user needs to specify a plurality of transmission destinations of the data.

Although the names that are frequently used are displayed in the technique disclosed in PTL 1, it is not the technique having an intention to specify transmission destinations for a broadcast transmission. Also, in the technique disclosed in PTL 1, in specifying the transmission destination, it is necessary for a user to look for a desired transmission destination from many names being displayed. This puts a heavy burden on the user, and a wrong transmission destination may be specified or a transmission destination may be missed from being specified.

In the technique disclosed in PTL 2, in order to facilitate the specification of a plurality of transmission destinations, the list of destinations related to the specified destination is displayed. However, the technique is not for facilitating the specification of transmission destinations in a broadcast transmission. Also, in order to display the list, it is necessary to store in advance the mail addresses to be transmission origins and the mail addresses registered as the destinations in association with usage, respectively. This requires labor.

The present invention has been made in view of the above circumstances and, has an object of making it possible to specify desired transmission destinations easily and accurately when a user is performing a broadcast transmission.

A transmitting apparatus according to an aspect of the present invention includes: an image obtaining device that obtains image data; an operating device for specifying a transmission destination of the image data; a transmitting device that transmits the image data to the transmission destination specified through the operating device; a display; a storage device; and a controller. When a broadcast transmission is performed, the controller makes a plurality of transmission destinations to which the broadcast transmission has been performed correspond to one another and causes the storage device to store the plurality of transmission destinations as history information, and when the transmission destination specified through the operating device is included in the history information, the controller causes the display to display, as first information, a transmission destination stored in the storage device in correspondence to the transmission destination specified.

An image forming apparatus according to another aspect of the present invention includes the transmitting apparatus described above, and an image forming device that forms an image based on the image data onto a recording medium.

According to the present invention, in specifying the transmission destinations to which to perform a broadcast transmission, the transmission destinations that are highly likely to be specified by the user as the transmission destinations for the broadcast transmission are displayed. Therefore, in performing a broadcast transmission, the user can easily specify desired transmission destinations. In addition, a possibility that wrong transmission destinations are specified or a transmission destination is missed from being specified becomes lower, so that the user can accurately specify desired transmission destinations when performing a broadcast transmission.

### BRIEF DESCRIPTION OF DRAWINGS

FIG. 1 is a perspective view showing an outer appearance of an image forming apparatus that includes a transmitting apparatus according to one embodiment of the present invention.

FIG. 2 is a block diagram showing an internal configuration of the image forming apparatus that includes the transmitting apparatus according to one embodiment of the present invention.

FIG. 3 is a flowchart showing transmission destination display processing.

FIG. 4 is a flowchart showing the transmission destination display processing.

FIG. 5 is a diagram showing one example of a home screen.

FIG. 6 is a diagram showing one example of a setting screen.

FIG. 7 is a diagram showing one example of a first screen.

FIG. 8 is a diagram showing one example of a second screen.

FIG. 9 is a diagram showing one example of a third screen.

FIG. 10 is a diagram showing another example of the second screen.

### DESCRIPTION OF EMBODIMENTS

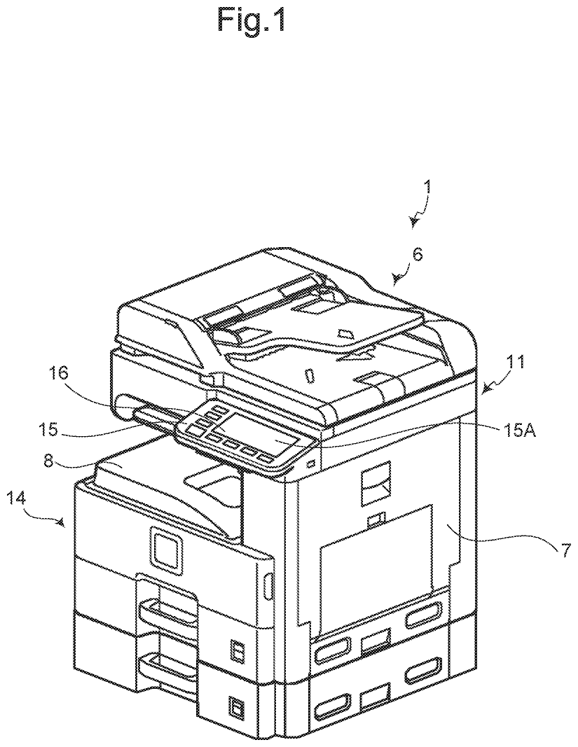

Hereinafter, a description will be given of a transmitting apparatus and an image forming apparatus according to one embodiment of the present invention, with reference to the drawings. FIG. 1 is a perspective view showing an outer appearance of the image forming apparatus that includes the transmitting apparatus according to one embodiment of the present invention.

The image forming apparatus 1 is a multifunction peripheral having multiple functions, including a facsimile transmission function, a copy function, a print function, and a scan function.

In the present embodiment, the image forming apparatus 1 has a transmission function of transmitting image data obtained by an image reading device 11 to a transmission destination specified by a user. The above transmission destination is not specifically limited so long as it is information by which the transmission destination of the image data can be identified; for example, the above transmission destination indicates: a destination such as an email address, an internet protocol (IP) address, or a facsimile number; or a transmission destination name.

With reference to FIG. 1, in a housing 7 of the image forming apparatus 1, there are multiple devices for realizing the various functions of the image forming apparatus 1 are housed. For example, in the housing 7, the image reading device 11, an image forming device 12 (not shown in FIG. 1), a fixing device (not shown in FIG. 1), and a paper feeding device 14 are housed.

The image reading device 11 is an auto document feeder (ADF) including: a document carrying device 6 that carries a document; and a scanner that optically reads an original document carried by the document carrying device 6 or an original document placed on a contact glass. The image reading device 11 illuminates the original document with a light irradiation part and receives the reflected light with a charge-coupled device (CCD) sensor, to thereby read the original document and generating image data. The image reading device 11 corresponds to the image obtaining device recited in Claims.

The image forming device 12 includes a photoreceptor drum, a charging device, an exposure device, a developing device, and a transfer device. Based on the image data generated by the image reading device 11, or based on image data sent from a personal computer or other facsimile device (both of which are connected via a network), the image forming device 12 forms a toner image on a recording sheet fed by the paper feeding device 14.

The fixing device 13 applies heat and pressure onto the recording sheet, on a surface of which the toner image is formed by image forming processing of the image forming device 12, to thereby fix the toner image on the recording sheet. After going through the fixing by the fixing device 13, the recording sheet on which an image is formed is discharged to a paper discharge tray 8.

The paper feeding device 14 pulls out recording sheets contained in a sheet cassette or recording sheets placed on a manual feed tray, sheet by sheet, by use of an un-illustrated pickup roller, and feeds forward the pulled-out recording sheet to the image forming device 12.

The image forming apparatus 1 is provided with an operating device 15. Through the operating device 15, the user can, for example, input instructions regarding various functions executable by the image forming apparatus 1 and specify a transmission destination of image data. The operating device 15 includes a display 16. The display 16 is a display device including a liquid crystal display. The display 16 displays various types of screens related to various functions executable by the image forming apparatus 1. The operating device 15 includes a touch panel 15A superposedly disposed on the display 16. The touch panel 15A detects various operations by the user, such as a touch operation, a swipe operation, and a flick operation.

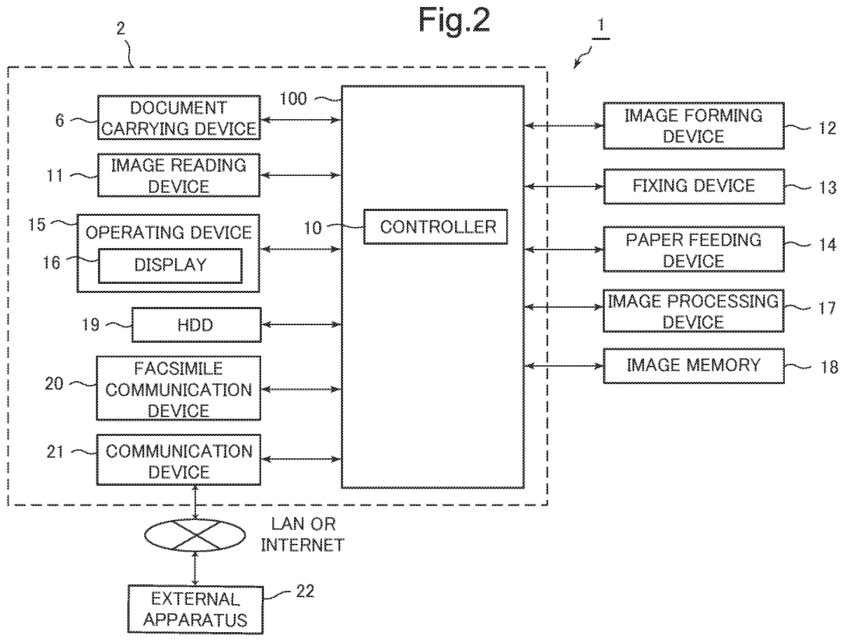

FIG. 2 is a block diagram showing an internal configuration of the image forming apparatus that includes the transmitting apparatus according to one embodiment of the present invention. With reference to FIG. 2, the image forming apparatus 1 includes a control device 100. The control device 100 includes a processor, a random access memory (RAM), a read only memory (ROM), and so on. The processor is, for example, a central processing unit (CPU), a micro-processing unit (MPU), or an application specific integrated circuit (ASIC). The control device 100 acts as the controller 10 through the processor executing a control program stored in a built-in ROM or hard disk drive (HDD) 19.

The control device 100 is electrically connected with the document carrying device 6, the image reading device 11, the image forming device 12, the fixing device 13, the paper feeding device 14, the operating device 15, an image processing device 17, an image memory 18, the HDD 19, a facsimile communication device 20, a communication device 21, and so on. In the present embodiment, the document carrying device 6, the image reading device 11, the operating device 15, the display 16, the HDD 19, the facsimile communication device 20, the communication device 21, and the control device 100 act as a transmitting apparatus 2 for realizing the transmission destination display processing.

The control device 100 governs overall control of the image forming apparatus 1. More specifically, the control device 100 executes operations for each of the devices in the image forming apparatus 1, and processing such as communication with an external apparatus 22 connected via a network (for example a personal computer).

The image processing device 17 executes, as necessary, an image processing on the image data generated by the image reading device 11.

The image memory 18 includes a region for temporarily storing image data targeted for printing generated by the image reading device 11.

The HDD 19 is a large-capacity storage device for storing various data including the image data generated by the image reading device 11. The HDD 19 stores various computer programs for realizing general operations of the image forming apparatus 1.

The HDD 19 stores a control program for executing the transmission destination display processing according to the present embodiment. Through being operated in accordance with the control program, the processor executes, as the controller 10, the transmission destination display processing according to the present embodiment. The controller 10 may not be implemented in accordance with the computer program but may be constituted by a hardware circuit.

A user can register by input through the operating device 15 a transmission destination of image data in an address book stored in the HDD 19. In the address book, destinations, such as an email address, an IP address, or a facsimile number, and the transmission destination names are correspondingly stored.

By input through the operating device 15, for example, the user specifies a plurality of transmission destinations that are registered in advance as a mailing list, and registers the transmission destinations as groups. The HDD 19 correspondingly stores, as group registration information, the specified plurality of transmission destinations and group names for identifying the group. The group is, for example, set according to a common attribute, such as a belonging section.

In performing a broadcast transmission, the controller 10 makes the plurality of transmission destinations to which the broadcast transmission has been performed correspond to one another and causes the HDD 19 to store the plurality of transmission destinations as history information for each transmission job of the broadcast transmission. Here, the broadcast transmission indicates a transmission job of sending the same image data to more than one transmission destination.

The facsimile communication device 20 makes a connection to a public line and sends and receives image data via the public line.

The communication device 21 includes a communication module such as a local area network (LAN) board. The image forming apparatus 1 performs, via the communication device 21, data communication with the external apparatus 22 (for example a personal computer) on the network.

The facsimile communication device 20 and the communication device 21 correspond to the transmitting device recited in Claims.

A power supply (not shown) is connected to each device in the image forming apparatus 1, and through the power is being supplied from this power supply, each device in the image forming apparatus 1 operates.

### [Operation]

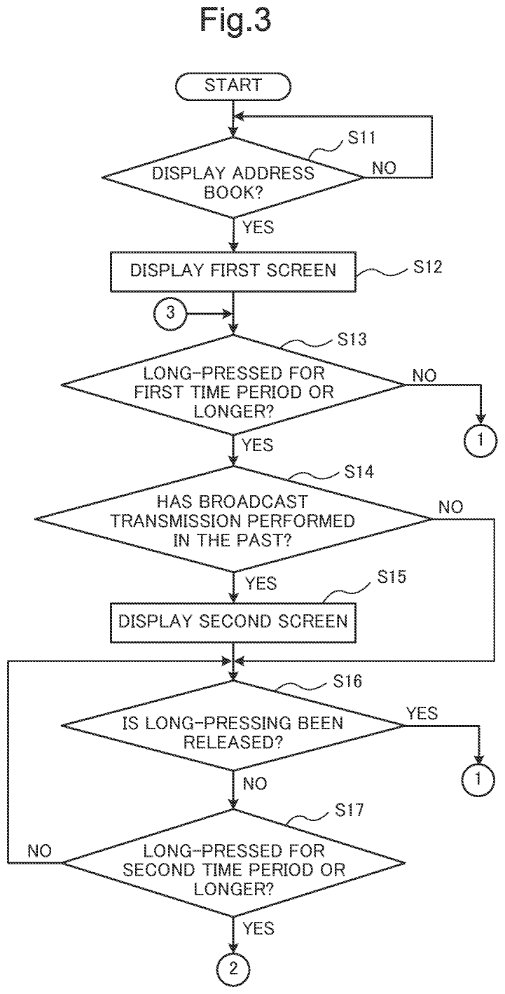

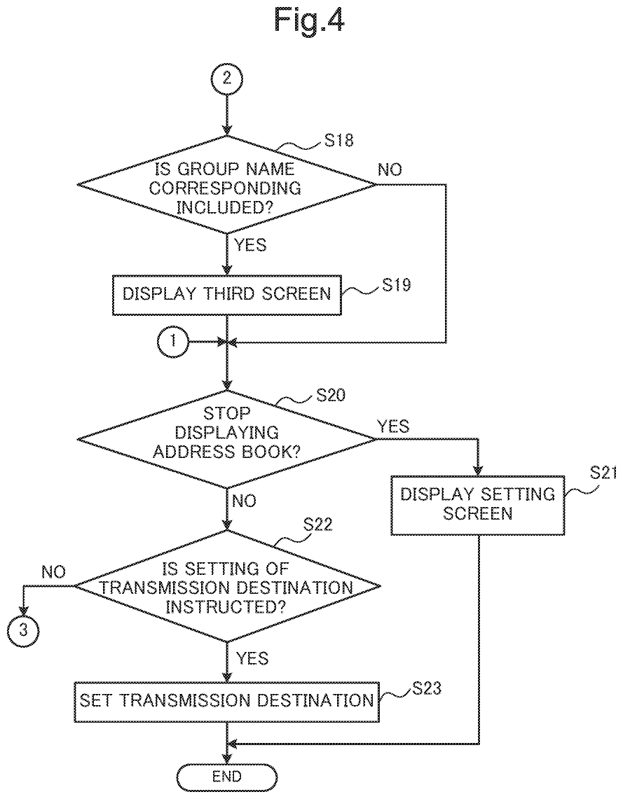

FIG. 3 and FIG. 4 are flowcharts showing the transmission destination display processing. Hereinafter, description will be given of the control program for executing the transmission destination display processing together with description of the operation of the image forming apparatus 1. Upon causing the display 16 to display a setting screen for setting the transmission destination of image data, the controller 10 starts the execution of the control program.

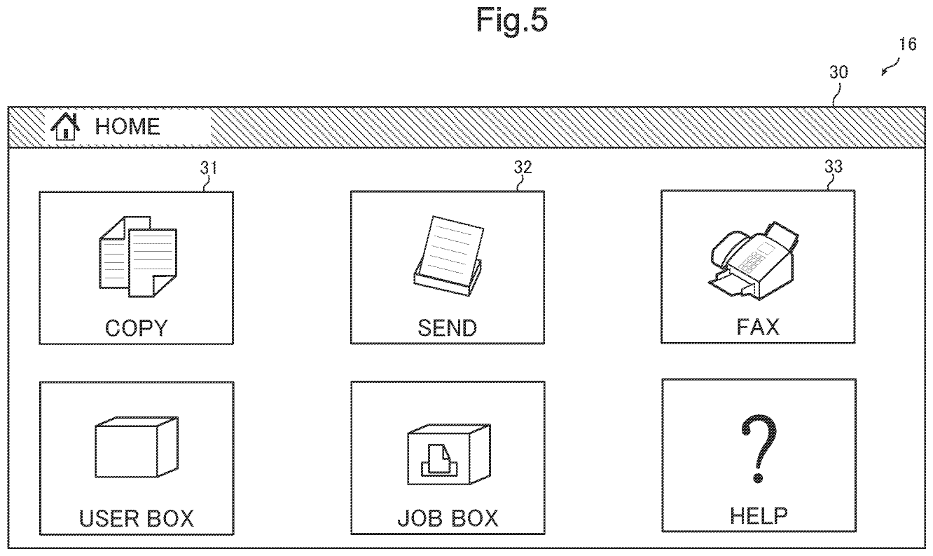

When the power of the image forming apparatus 1 is turned on, the controller 10 causes the display 16 to display a home screen for selecting any one of the multiple functions that can be executed by the image forming apparatus 1. FIG. 5 is a diagram showing one example of the home screen. With reference to FIG. 5, the home screen 30 includes, as soft keys, a key 31 for selecting a copy function, a key 32 for selecting a transmission function, and a key 33 for selecting a facsimile function.

The user places on the contact glass of the image reading device 11 an original document to be sent and presses down the key 32. Upon receiving the pressing of the key 32 through the touch panel 15A, the controller 10 causes the display 16 to display the setting screen for setting the transmission destination of the image data.

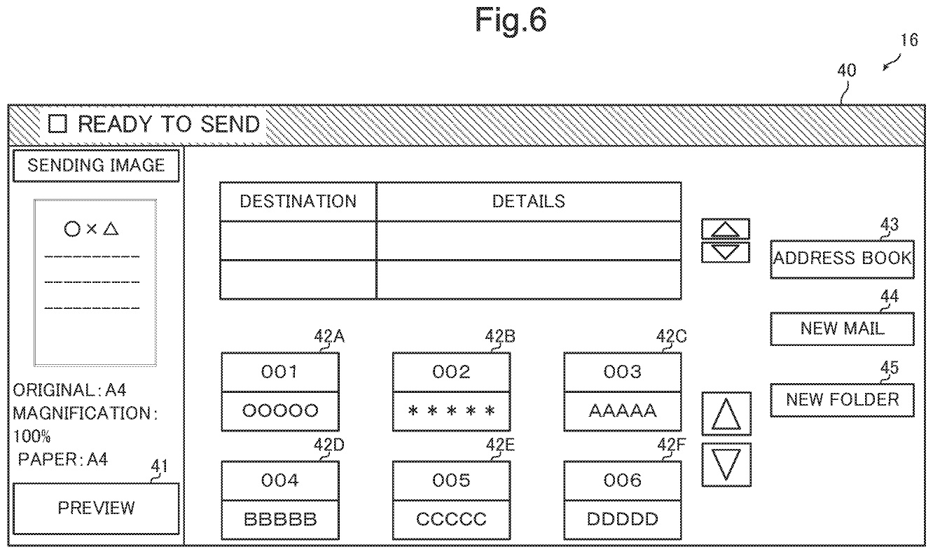

FIG. 6 is a diagram showing one example of a setting screen 40. With reference to FIG. 6, the setting screen 40 includes, as soft keys, a key 41 for displaying an image of the document to be sent as a preview image, keys 42A to 42F for selecting a transmission destinations with one touch, a key 43 for displaying the address book, a key 44 for inputting a transmission destination not registered in the address book, a key 45 for newly creating a shared folder not registered in the address book, and so on.

It is assumed that the user who has seen the setting screen 40 presses the key 43 to display the address book. Upon receiving the pressing of the key 43 through the touch panel 15A, the controller 10 determines that an instruction to display the address book is received (YES at step S11) and, based on the address book stored in the HDD 19, causes the display 16 to display a first screen (step S12).

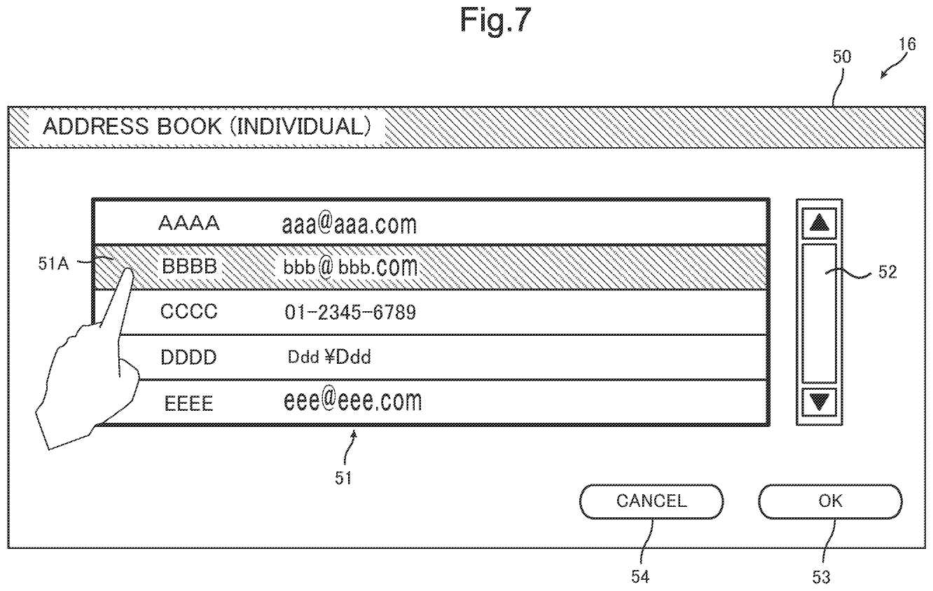

FIG. 7 is a diagram showing one example of the first screen. With reference to FIG. 7, the first screen 50 includes a region 51. In the region 51, transmission destinations included in the address book stored in the HDD 19 are displayed. Also, the first screen 50 includes a scroll bar 52, which is for changing the transmission destinations displayed in the region 51 to other transmission destinations in accordance with an operation by the user when all of the transmission destinations included in the address book cannot be displayed in the region 51.

The first screen 50 further includes, as soft keys, a key 53 for setting the transmission destination specified by the user to the transmission destination of the image data and a key 54 for stopping the display of the address book and displaying the setting screen.

(1) Case of Not Performing Broadcast Transmission

The user sees the first screen 50 and specifies a transmission destination by performing a touch operation on the region 51A where the transmission destination desired is being displayed. Upon receiving the touch operation by the user through the touch panel 15A, the controller 10 causes the display 16 to display the region 51A in a color different from regions where other transmission destinations are being displayed.

It is assumed that the user releases a finger from the region 51A within three seconds after he or she performed the touch operation on the region 51A. Based on a signal, which is outputted from the touch panel 15A and indicates that the touch operation on the region 51A is no longer being detected, the controller 10 determines that the region 51A is not being long-pressed for a predetermined first time period (in this case three seconds) or longer (NO at step S13).

The user presses the key 53 after releasing the finger from the region 51A. Upon receiving the pressing of the key 53 through the touch panel 15A, the controller 10 determines that an instruction for stopping the display of the address book is not being received (NO at step S20), determines that an instruction for setting the transmission destination is being received (YES at step S22), and sets the transmission destination being specified by the user as the transmission destination of the image data (step S23). In this case, the controller 10 sets the transmission destination being displayed in the region 51A as the transmission destination of the image data.

After setting the transmission destination of the image data, the user inputs an instruction for sending the image data through the operating device 15. Upon receiving the instruction for sending the image data, the controller 10 causes the image reading device 11 to generate image data based on the document placed on the contact glass, and sends, through the communication device 21, the generated image data to the specified transmission destination.

Also, the user can input through the operating device 15 an instruction for printing an image that is based on the generated image data. Upon receiving the instruction, the controller 10 causes the image forming device 12 and so on to print the image that is based on the generated image data on a recording sheet.

Here, when the user presses the key 54 with an intention to stop the display of the first screen 50, the controller 10 determines that the instruction for stopping the display of the address book is being received (YES at step S20) and causes the display 16 to display the setting screen 40 (step S21).

(2) Case of Performing Broadcast Transmission

(2-1) Case of Specifying Transmission destinations from Transmission destinations to Which Broadcast Transmission Has Been Performed in the Past

The user sees the first screen 50 and specifies the transmission destination by performing a touch operation on the region 51A where the transmission destination desired is being displayed. Upon receiving the touch operation by the user through the touch panel 15A, the controller 10 causes the display 16 to display the region 51A in a color different from regions where other transmission destinations are being displayed.

It is assumed that after the user performs the touch operation on the region 51A, the user is long-pressing the region 51A for three seconds or longer without releasing the finger from the region 51A. Upon determining that, based on a signal, which is outputted from the touch panel 15A and indicates that the touch operation on the region 51A is being detected, the region 51A has been long-pressed for the predetermined first time period (in this case three seconds) or longer (YES at step S13), the controller 10 determines, based on the history information stored in the HDD 19, whether or not a broadcast transmission has been performed in the past for the specified transmission destination (step S14).

When the specified transmission destination is included in the history information stored in the HDD 19, the controller 10 determines that a broadcast transmission has been performed in the past (YES at step S14), and based on the history information stored in the HDD 19, causes the display 16 to display a second screen (step S15).

In causing the second screen to be displayed, the controller 10 extracts, from the history information stored in the HDD 19, the transmission destinations correspondingly stored with the specified transmission destination. The controller 10 rearranges the extracted transmission destinations in a descending order of the number of times that the broadcast transmissions were performed, and generates first display data for displaying the second screen. If there are same transmission destinations in the extracted transmission destinations, the controller 10 generates the first display data, leaving only one out of the same transmission destinations.

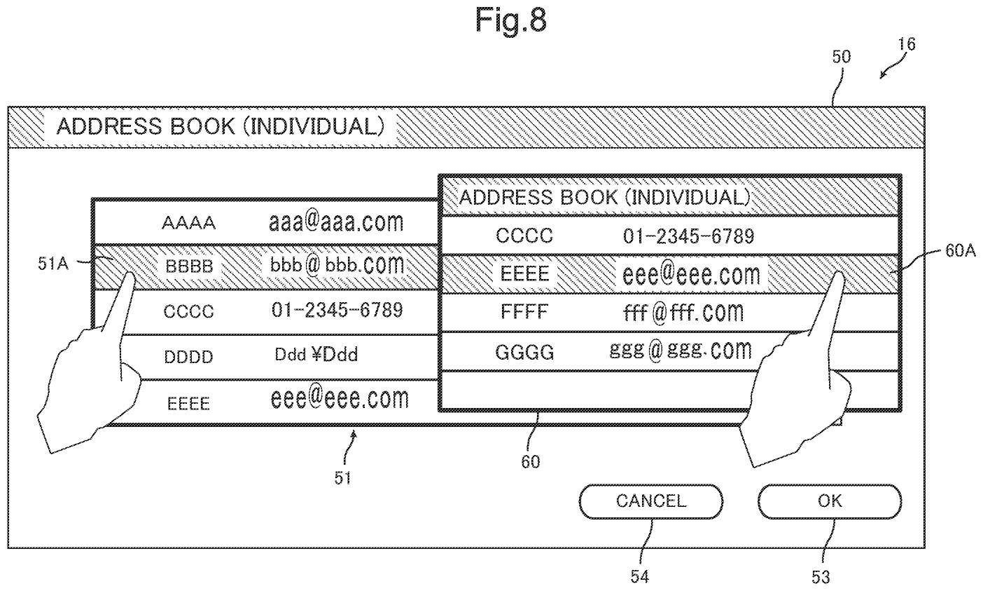

FIG. 8 is a diagram showing one example of the second screen. With reference to FIG. 8, based on the first display data generated as described above, the controller 10 causes the display 16 to display the second screen 60. The controller 10 causes the display 16 to display the second screen 60 so as to be overlaid on the first screen 50. The controller 10 causes the display 16 to display, within the second screen 60, as the first information, the transmission destinations to which broadcast transmissions have been previously performed along with the specified transmission destination. The controller 10 causes the display 16 to display the transmission destinations, which is as the first information, in the descending order of the number of times that the broadcast transmissions were performed.

When the user sees the second screen 60 and performs the touch operation on the region 51A, and then, within six seconds, releases his or her finger from the region 51A, based on the signal, which is outputted from the touch panel 15A and indicates that the touch operation on the region 51A is no longer being detected, the controller 10 determines that the long-pressing is released (YES at step S16). At this time point, without releasing the specification on the region 51A, the controller 10 causes the display 16 to maintain the state where the region 51A is being displayed in the color different from the regions where other transmission destinations are being displayed.

Out of the second screen 60, the user specifies the transmission destination by performing a touch operation on the region 60A where the transmission destination desired is being displayed. Upon receiving the touch operation by the user through the touch panel 15A, the controller 10 causes the display 16 to display the region 60A in a color different from regions where other transmission destinations are being displayed. In further specifying other transmission destination, by performing the above-described touch operation on other regions where the transmission destination desired is being displayed, the user specifies the transmission destination.

The user presses the key 53 after specifying the transmission destination on the second screen 60. Upon receiving the pressing of the key 53 through the touch panel 15A, the controller 10 determines that the instruction for stopping the display of the address book is not being received (NO at step S20), determines that the instruction for setting the transmission destination is being received (YES at step S22), and sets the transmission destination being specified by the user as the transmission destination of the image data (step S23). In this case, the controller 10 sets the transmission destinations being displayed in the region 51A and the region 60A as the transmission destinations of the image data.

After setting the transmission destinations of the image data, the user inputs, through the operating device 15, an instruction for sending the image data. Upon receiving the instruction for sending the image data, the controller 10 causes the image reading device 11 to generate the image data that is based on the document placed on the contact glass, and sebds, through the communication device 21, the generated image data to the specified transmission destinations.

Also, the user can input the instruction for printing the image that is based on the generated image data through the operating device 15. Upon receiving the instruction, the controller 10 causes the image forming device 12 and so on to print the image that is based on the generated image data on a recording sheet.

(2-2) Case of Specifying Transmission Destinations by Using Group

The user sees the first screen 50 and specifies the transmission destination by performing a touch operation on the region 51A where the transmission destination desired is being displayed. Upon receiving the touch operation by the user through the touch panel 15A, the controller 10 causes the display 16 to display the region 51A in a color different from regions where other transmission destinations are being displayed.

It is assumed that after the user performs the touch operation on the region 51A, the user is long-pressing the region 51A for three seconds or longer without releasing the finger from the region 51A. Upon determining, based on the signal, which is outputted from the touch panel 15A and indicates that the touch operation on the region 51A is being detected, that the region 51A has been long-pressed for the predetermined first time period (in this case three seconds) or longer (YES at step S13), the controller 10 determines, based on the history information stored in the HDD 19, whether or not a broadcast transmission has been performed in the past for the specified transmission destination (step S14).

When the specified transmission destination is not included in the history information stored in the HDD 19, the controller 10 determines that a broadcast transmission has not been performed to the specified transmission destination in the past (NO at step S14), and based on the signal outputted from the touch panel 15A, determines whether the long-pressing is released (step S16).

It is assumed that after the user performs the touch operation on the region 51A, the user is long-pressing the region 51A for six seconds or longer without releasing his or her finger from the region 51A. Upon determining, based on the signal, which is outputted from the touch panel 15A and indicates that the touch operation on the region 51A is being detected, that the region 51A has been long-pressed for a predetermined second time period (in this case six seconds) or longer (YES at step S17), the controller 10 determines whether the group name corresponding to the specified transmission destination is included in the group registration information stored in the HDD 19 (step S18).

When the group name made to correspond to the specified transmission destination is included in the group registration information, the controller 10 determines that the group name corresponding is included (YES at step S18), and based on the group registration information, causes the display 16 to display a third screen (step S19).

When the group name made to correspond to the specified transmission destination is not included in the group registration information, the controller 10 determines that the group name corresponding is not included (NO at step S18), and goes to the processing of step S20.

In causing the third screen to be displayed, the controller 10 extracts, from the group registration information stored in the HDD 19, the group name made to correspond to the specified transmission destination. Based on the extracted group name, the controller 10 generates second display data for displaying the third screen.

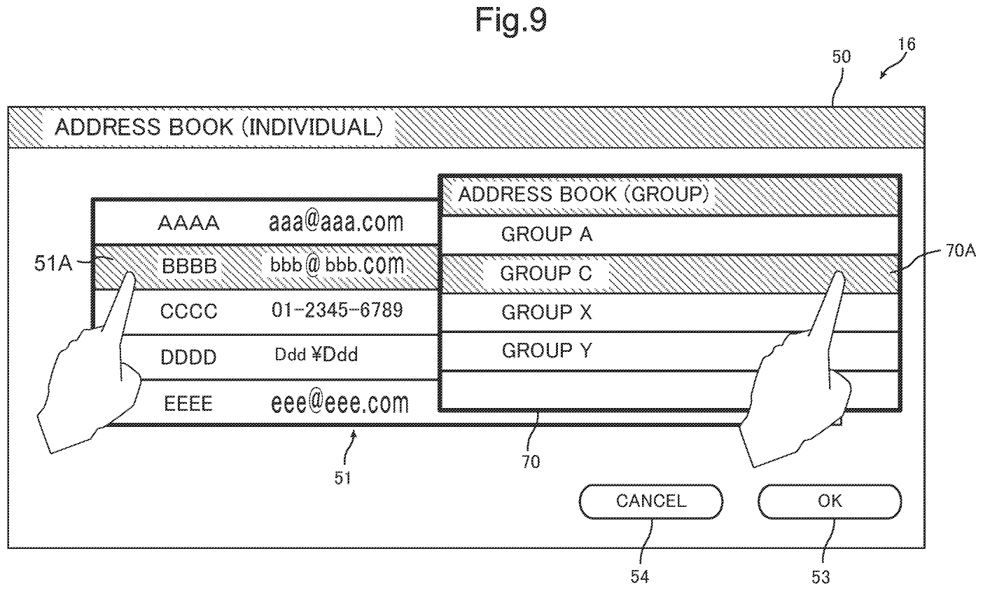

FIG. 9 is a diagram showing one example of the third screen. With reference to FIG. 9, based on the second display data generated as described above, the controller 10 causes the display 16 to display a third screen 70. The controller 10 causes the display 16 to display the third screen 70 so as to be overlaid on the first screen 50. The controller 10 causes the display 16 to display, within the third screen 70, as the second information, group names made to correspond to the specified transmission destination.

Out of the third screen 70, the user specifies the transmission destination by performing a touch operation on the region 70A where the group name desired is being displayed. Upon receiving the touch operation by the user through the touch panel 15A, the controller 10 causes the display 16 to display the region 70A in a color different from regions where other transmission destinations are being displayed. In further specifying other group, by performing the above-described touch operation on other region where the group name desired is being displayed, the user specifies the transmission destination.

The user presses the key 53 after specifying the transmission destination on the third screen 70. Upon receiving the pressing of the key 53 through the touch panel 15A, the controller 10 determines that the instruction for stopping the display of the address book is not being received (NO at step S20), determines that the instruction for setting the transmission destination is being received (YES at step S22), and sets the transmission destination being specified by the user as the transmission destination of the image data (step S23). In this case, as the transmission destinations of the image data, the controller 10 sets the transmission destination being displayed in the region 51A and transmission destinations other than the transmission destination being displayed in the region 51A among the plurality of transmission destinations made to correspond to the group name being displayed in the area 60A.

After setting the transmission destinations of the image data, the user inputs, through the operating device 15, an instruction for sending the image data. Upon receiving the instruction for sending the image data, the controller 10 causes the image reading device 11 to generate the image data that is based on the document placed on the contact glass, and sends, through the communication device 21, the generated image data to the specified transmission destinations.

Also, the user can input the instruction for printing the image that is based on the generated image data through the operating device 15. Upon receiving the instruction, the controller 10 causes the image forming device 12 and so on to print the image that is based on the generated image data on a recording sheet.

According to the above embodiment, when a broadcast transmission is performed, the controller 10 makes the plurality of transmission destinations to which the broadcast transmission has been performed correspond to one another and causes the HDD 19 to store the plurality of transmission destinations as the history information. When the history information includes the transmission destination specified through the operating device 15, the controller 10 causes the display 16 to display, as the first information, the transmission destinations stored in the HDD 19 in correspondence to the transmission destination specified.

Thereby, in specifying the transmission destinations to which to perform broadcast transmission, the transmission destinations that are highly likely to be specified by the user as the transmission destinations for the broadcast transmission are displayed. Therefore, in performing a broadcast transmission, the user can easily specify desired transmission destinations. In addition, a possibility that the wrong transmission destination is specified or the transmission destination is missed from being specified becomes lower, so that the user can accurately specify desired transmission destinations when performing a broadcast transmission.

The controller 10 causes the HDD 19 to store the history information when the broadcast transmission is performed. Thus, the user does not need to pre-register the plurality of transmission destinations, to which broadcast transmissions have been performed in the past, in order to display the first information. It is, therefore, possible to omit the user's trouble due to the registering, and this further improves user convenience.

Furthermore, according to the above embodiment, the controller 10 causes the display 16 to display the first information under the state where the transmission destination is specified through the operating device 15 and the region 51A is long-pressed for the first time period or longer on the touch panel 15A, when the specified transmission destination is included in the history information. The operation of long-pressing the region 51A for the first time period or longer is one example of the predetermined first operation in Claims.

As described thus far, the user is capable of causing the display 16 to display the first information by the simple operation of long-pressing the region 51A on the touch panel 15A for the first time period (such as three seconds) or longer. Accordingly, user convenience is further improved.

Furthermore, according to the above embodiment, the HDD 19 correspondingly stores the plurality of transmission destinations and the group name for identifying the group in advance, and when the HDD 19 stores the group name made to correspond to the transmission destination specified through the operating device 15, the controller 10 causes the display 16 to display the group name as the second information. The group name is one example of the group information in Claims.

As described above, in specifying the transmission destinations to which to perform broadcast transmission, the group name including the transmission destinations that are highly likely to be specified by the user as the transmission destinations for the broadcast transmission are displayed. Therefore, in performing a broadcast transmission, the user can specify the desired transmission destinations more easily. In addition, the possibility that the wrong transmission destination is specified or the transmission destination is missed from being specified becomes even lower, so that the user can more accurately specify desired transmission destinations when performing a broadcast transmission.

Furthermore, according to the above embodiment, the controller 10 causes the display 16 to display the second information under a state where the transmission destination is specified through the operating device 15 and the region 51A is long-pressed for the second time period or longer, when the group name made to correspond to the specified transmission destination is stored in the HDD 19. The operation of long-pressing the region 51A for the second time period or longer is one example of the second operation in Claims.

As described thus far, the user is capable of causing the display 16 to display the second information by the simple operation of long-pressing the touch panel 15A for the second time period (such as six seconds) or longer. Accordingly, user convenience is further improved.

Furthermore, according to the above embodiment, upon receiving through the operating device 15 the instruction for printing the image that is based on the generated image data, the controller 10 causes the image forming device 12 and so on to print the image that is based on the generated image data on a recording sheet.

Thereby, in sending the image data, the user can check the content of the image data to be sent, and this further improves user convenience.

### (First Modified Example)

The configuration of the image forming apparatus 1 including the transmitting apparatus 2 according to a first modified example of the present invention is the same as that of the image forming apparatus 1 according to the above-described embodiment except that a configuration of the second screen is different. The difference from the above-described embodiment will be described below.

In causing the second screen to be displayed, the controller 10 extracts, from the history information stored in the HDD 19, the transmission destinations correspondingly stored with the specified transmission destination, for each transmission job. The controller 10 rearranges, for each of the transmission jobs, the transmission destination name corresponding to the transmission destinations for each of the extracted transmission jobs in order from the oldest date and time (i.e., ascending order) when the broadcast transmissions were performed, and generates third display data for displaying the second screen.

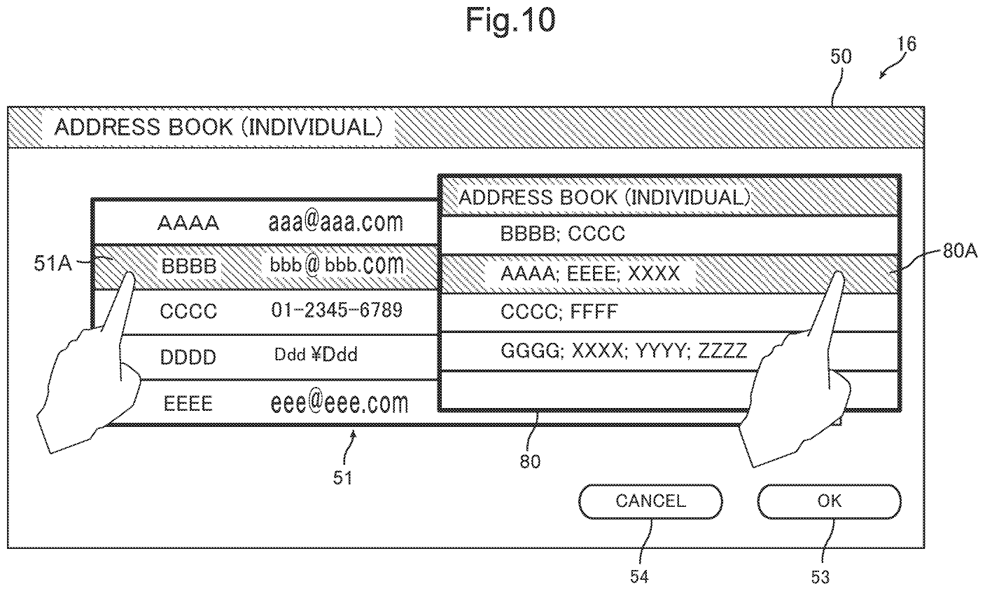

FIG. 10 is a diagram showing another example of the second screen. With reference to FIG. 10, based on the third display data generated as described above, the controller 10 causes the display 16 to display the second screen 80. The controller 10 causes the display 16 to display the second screen 80 so as to be overlaid on the first screen 50. The controller 10 causes the display 16 to display, within the second screen 80, as the first information, the transmission destination names corresponding to the transmission destinations to which broadcast transmissions have been previously performed along with the specified transmission destination, for each of the transmission jobs. The controller 10 causes the display 16 to display the transmission destination names which are as the first information, in a state in which the transmission destination names are arranged, for each transmission job, in an order from the oldest date and time when the broadcast transmissions were performed.

The user sees the second screen 80 and specifies the transmission destination by performing a touch operation on the region 80A where the transmission destination desired is being displayed. Upon receiving the touch operation by the user through the touch panel 15A, the controller 10 causes the display 16 to display the region 80A in a color different from regions where other transmission destinations are being displayed. By the aforesaid touch operation by the user, the transmission destinations corresponding to the entire transmission destination names being displayed in the region 80A are specified as the transmission destinations of the image data. In further specifying other transmission destination, by performing the above-described touch operation on other regions where the transmission destination desired is being displayed, the user specifies the transmission destination.

### (Other Modified Examples)

In the above embodiment, the group names made to correspond to the specified transmission destination are displayed in the third screen 70. The present invention, however, is not limited to such embodiment. For example, among the plurality of transmission destinations made to correspond to the group name, instead of the group name, a transmission destination other than the specified transmission destination may be displayed in the third screen 70.

When, in the third screen 70, the region 70A where the desired group name is being displayed is long-pressed by the user, it may be configured that the controller 10 switches the display of the group names so as that, among the plurality of transmission destinations made to correspond to the group name, the transmission destination other than the specified transmission destination be displayed.

In the above embodiment, as the predetermined first operation, the operation of long-pressing for the first time period or longer has been exemplified. However, the present invention is not limited to such embodiment. For example, an operation of touching two points on the second screen 60 or the second screen 80 at the same time, an operation of swiping or flicking on the second screen 60 or the second screen 80 may be predetermined as the first operation.

In the above embodiment, as the predetermined second operation, the operation of long-pressing for the second time period or longer has been exemplified. However, the present invention is not limited to such embodiment. For example, an operation of touching two points on t the third screen 70 at the same time, an operation of swiping or flicking on the third screen 70 may be predetermined as the second operation.

In the above embodiment, as the group information, group names have been used. However, the present invention is not limited to such embodiment. The group information is not limited particularly so long as a group can be identified thereby. For example, the group information may be a group identification (ID), a group number, or the like.

In the above embodiment, as the image obtaining device, the image reading device 11 has been exemplified. However, the present invention is not limited to such embodiment. For example, it may be configured that the image data is stored in the HDD 19 in advance, and the controller 10 transmits the image data selected by the user through the operating device 15 to the specified transmission destination. In such case, the HDD 19 acts as the image obtaining device.

In the above embodiment, the image forming device 12 and so on form the image on the recording sheet. However, the present invention is not limited to such embodiment. The image forming device 12 and so on may form the image not only on the recording sheet but also on other recording media. Examples of other recording media include overhead projector (OHP) sheets.

The present invention is not limited to the above embodiments and can be modified in various ways. For example, although in the above embodiments, the description is given taking a color multifunction peripheral as one embodiment of the image forming apparatus according to the present invention, it is merely illustrative. A monochrome multifunction peripheral or other electronic apparatus, for example, a printer, a copier, or another image forming apparatus such as a facsimile machine may be used.

The configurations and processing of the above embodiments described with reference to FIG. 1 to FIG. 10 are merely one embodiment exemplifies the present invention, and not intended to limit the present disclosure to the above particular configurations and processing.

1. A transmitting apparatus comprising:
an image obtaining device that obtains image data;
an operating device through which a transmission destination of the image data is specified;
a transmitting device that transmits the image data to the transmission destination specified through the operating device;
a display;
a storage device; and
a control device that includes a processor and, through the processor executing a control program, acts as a controller,
wherein when a broadcast transmission is performed, the controller makes a plurality of transmission destinations to which the broadcast transmission has been performed correspond to one another and causes the storage device to store the plurality of transmission destinations as history information,
the operating device includes a touch panel superposedly disposed on the display,
under a state where the transmission destination is specified through the operating device and a predetermined first operation is made on the touch panel, when the transmission destination specified is included in the history information, the controller causes the display to display, as first information, a transmission destination stored in the storage device in correspondence to the transmission destination specified, and
the first operation is an operation of long-pressing a predetermined region for a predetermined first time period or longer.

2. (canceled)

3. The transmitting apparatus according to claim 1, wherein
the storage device correspondingly stores in advance the plurality of transmission destinations and group information for identifying a group, and
when group information made to correspond to the transmission destination specified through the operating device is stored in the storage device, the controller causes the display to display the group information as second information.

4. The transmitting apparatus according to claim 3, wherein
under a state where the transmission destination is specified through the operating device and a predetermined second operation is made on the touch panel, when the group information made to correspond to the transmission destination specified through the operating device is stored in the storage device, the controller causes the display to display the second information.

5. (canceled)

6. The transmitting apparatus according to claim 4, wherein the second operation is an operation of long-pressing the predetermined region for a predetermined second time period or longer.

7. The transmitting apparatus according to claim 1, wherein when the transmission destination specified through the operating device is included in the history information, the controller causes the display to display, as the first information, transmission destinations stored in the storage device in correspondence to the transmission destination specified, in a state in which the transmission destinations are arranged in a descending order of a number of times that broadcast transmissions have been performed.

8. The transmitting apparatus according to claim 1, wherein when the transmission destination specified through the operating device is included in the history information, the controller causes the display to display, as the first information, transmission destinations stored in the storage device in correspondence to the transmission destination specified, in a state in which the transmission destinations are arranged, for each transmission job, in an order from the oldest date and time when broadcast transmissions have been performed.

9. An image forming apparatus comprising:
the transmitting apparatus according to claim 1; and
an image forming device that forms an image based on the image data onto a recording medium.
